(19) United States
(12) Patent Application Publication
(10) Pub. No.: US 2021/0061540 A1
(43) Pub. Date: Mar. 4, 2021

(54) METHOD OF PREPARING AND SERVING A MEAL PACKAGE

(71) Applicant: Compass Contract Services (U.K.) Limited, Birmingham (GB)

(72) Inventor: Greg Harrison, Chertsey (GB)

(73) Assignee: Compass Contract Services (U.K.) Limited, Birmingham (GB)

(21) Appl. No.: 16/961,101

(22) PCT Filed: Jan. 8, 2019
(86) PCT No.: PCT/GB19/50039

§ 371 Date: Jul. 9, 2020

(30) Foreign Application Priority Data
Jan. 9, 2018 (GB) 1800321.0

(51) Int. Cl. B65D 81/34; B65B 5/06; B65B 7/28; B65D 25/04; A47G 19/02; A23L 5/10

(52) U.S. Cl. CPC B65D 81/3453; B65B 5/06; B65B 7/2878; A23V 2002/00; A47G 19/02; A23L 5/15; B65D 25/04

(57) ABSTRACT

A method of preparing and serving a meal package (10) comprising the steps of: preparing a meal package(10), including:disposing a food product (16, 17) into a container (11), the container (11) having an opening defining therein a volume for receiving the food product(16, 17); and sealing the container by securing a film (12) over or around the container (11);heating the meal package (10) in a microwave oven; removing the film from the container; serving the heated food product in the container; cleaning the used container after the food product has been consumed; and repeating the above steps for the used container.

The present invention relates to an improved system and method of preparing and serving a meal package.

A ready-meal or pre-prepared meal package is typically provided in a disposable container (for example a plastic bowl or tray) suitable for heating in a microwave oven. The disposable container is supposedly more convenient for the user as it is designed to be thrown away after the meal is consumed, thereby eliminating the need for any dishes to be washed. However, this is frequently not the case.

In practice, the disposable container often becomes very hot when the meal is heated to the required temperature. This makes it very difficult and hazardous for the user to serve the heated meal in the disposable container, especially if the meal is for a child, or an elderly or infirm person who may burn themselves on the container. Also, in many ready-meal packages, the plastic walls of the container are thin and become very flexible when heated. Consequently, the heated ready meal is easy to drop or spill when being transported or lifted. As a result, it is common for users to be forced to serve the ready meal in or on a non-disposable bowl or plate that requires cleaning after use.

Moreover, in the catering industry such as in hospitals, schools, care homes or other establishments which rely on pre-prepared meal packages, the disposable containers can be unsightly and unpopular, therefore the heated food is served in or on a non-disposable bowl or plate to make it more appealing to the consumer.

Environmental factors are also a globally important issue and individuals and companies are increasingly being put under pressure to reduce the amount of waste being sent to land-fills. Generally, the disposable pre-prepared meal containers cannot be recycled, which is not environmentally friendly. In large establishments, such as hospitals, schools or care homes, the amount of waste generated by these containers also poses a significant financial issue, as they may have to pay to have waste collected. They could also potentially incur fines or lose grants due to poor environmental target performance (i.e. by not reducing the amount of waste they generate).

In a first aspect of the present invention, there is provided a method of preparing and serving a meal package comprising the steps of:
preparing the meal package, including:
   disposing a food product into a container, the container having an opening defining therein a volume for receiving the food product; and
   sealing the container by securing a film over or around the container;
heating the meal package in a microwave oven;
removing the film from the container;
serving the heated food product in the container;
cleaning the used container after the food product has been consumed; and
repeating the above steps with the used container.

The present invention thus provides a pre-prepared meal package having a container that is reused, thereby reducing the amount of waste generated by the meal. This method of preparing and serving a meal package is therefore more environmentally friendly.

The present invention thus also provides a method of preparing and serving a meal package which is more cost effective for both the manufacturer and the customer as by reusing the containers the manufacturer saves the costs of making a new container for each meal, which potentially reduces the cost of each meal. The consumer may also save the cost of having the additional waste generated by disposable containers collected.

The container according to the present invention can be repeatedly cleaned and sanitised to high industry standards. It may be generally more sturdy and robust than disposable containers, which are designed to be single-use and made as cheaply as possible. Due to its construction, the heated meal can also be safely served in the container of the present invention, as the container does not become too hot or flexible during the heating process.

As such, the container of the present invention is more user-friendly and there is no need for the customer (for example the hospital) to purchase any additional plates or bowls in which to serve the meal.

In some embodiments, the container may be a bowl, or a plate, or a tray. Preferably, the container resembles a standard (i.e. non-disposable) bowl, or plate, or tray and so may be more appealing than a disposable container.

In some embodiments, the container is at least partially formed of polycarbonate. Both the container and the film must be suitable for repeated use in a microwave oven.

Optionally, the container may comprise an outer rim bounding the opening of the container, wherein the film may be secured to the outer rim using an adhesive, heat and/or pressure.

The film is typically designed to be disposed of after a single use when removed from the container. In some embodiments, the adhesive may be applied to the film before the film is secured to the container. In other embodiments the adhesive may be applied onto the container prior to applying the film.

Preferably, the adhesive and the film are selected such that the film can be removed from the container as a single piece (i.e. the film does not rip into multiple pieces when being removed). The film may comprise one or more tabs that extend beyond the container (for example beyond the outer rim of the container), thereby making it easier to grip the film when removing it from the container.

Alternatively, the film may define a capsule around the container, so that the film entirely surrounds the container. This may avoid any problems with sealing the film to the container.

Optionally, the film may comprise a non-return valve configured to release steam from the container during heating. This removes the need for the film to be pierced by the user in order to release internal pressure in the container. The use of a non-return valve in pre-prepared meal packaging is known, for example in European patent no. EP1076012.

The film may be at least partially formed of polypropylene. Preferably, the film is substantially transparent prior to heating of the meal package to allow the food-product to be seen through the film.

Optionally, the method may comprise preparing the meal package at a first location (i.e. the steps of disposing the food product into the container and sealing the container take place at a first location). At least one of the remaining method steps may occur at a second location.

The first location (i.e. where the meal package is prepared) may be a manufacturing site, such as a factory. The second location (i.e. where the meal is served) may be a hospital, or a school, or a care home, or any other establishment requiring catering facilities.

Optionally, the method may comprise the step of transporting the meal package from the first location to the second location. The method of transportation of the pre-prepared meal package(s) may depend on the distance between the first location and the second location. In some embodiments, the meal package(s) may be transported in a chilled environment, for example a refrigerated vehicle, so as to better preserve the food product.

The method may further comprise the step of transporting the used container back to the first location. This may take place before or after the container has been cleaned.

Optionally, the used containers may be collected from the second location at a frequency of, for example, once a day to be transported back to the first location. In other embodiments, the used containers may be collected more or less frequently (for example but not limited to twice a day, or once every other day, or once every week). This may depend on the number of meal packages used per day or the specific requirements of the customer.

The method of transportation used to transport the used containers back to the first location is not necessarily the same as the method of transportation used to transport the meal packages to the second location. For example, the used containers do not require refrigerating.

Optionally, the container may define therein a first volume and a second volume separated by a dividing member. The step of disposing a food product into the container may comprise disposing a first food product into the first volume and disposing a second food product into the second volume.

The first food product may be separated from the second food product by the dividing member, such that they do not come into contact during preparation, transport or heating. For example, the container may comprise at least one inner wall or compartment separating the first volume from the second volume.

Optionally, the container may further define therein a third volume separated from the first and second volumes by at least one further dividing member. The step of disposing a food product into the container may further comprise disposing a third food product into the third volume. Each dividing member may be formed out of a body of the container.

The third food product may be separated from both the first and second food products by the dividing members, such that they do not come into contact. For example, the container may comprise at least one inner wall or compartment separating the third volume from the first and second volumes.

In some embodiments, the meal package may comprise one, or two, or three or more food products. Multiple food products may be disposed in a single volume (or compartment) of the container, or the food products may be disposed in separate volumes (or products).

The food product(s) may be disposed into the container in accordance with a predetermined meal specification. This may be particularly important for pre-prepared meal packages for use in a hospital, as patients have strict dietary requirements.

The method may further comprise the step of storing the meal package in a chilled environment until the meal package is required to be heated. The meal package may be stored at the first location, or the second location, or a third location. The third location may be a food storage facility, such as a chilled warehouse. The duration for which the meal package may be stored may depend on the type of food product, and/or the storage conditions. For example, the meal package may be stored in a refrigerator for up to 7 days after being prepared.

The step of cleaning the used container (after the food product has been consumed) may comprise inserting the used container into a dishwasher or other industrial or commercial dish-cleaning apparatus. Optionally, any food debris may be required to be removed prior to inserting the used container into a dishwasher etc. In some embodiments, the plates may be cleaned at the first location afte being transported back from the second location, for example if the second location has no suitable cleaning facilities.

The repeating of the steps with respect to a single container may occur at least 10, 50, 100, 200 or 350 times.

In a second aspect of the present invention, there is provided a container, the container comprising an opening defining therein a volume for receiving a food product, the container being suitable for use as the container of the method of the first aspect of the invention. The container may be at least partially formed of polycarbonate.

In a third aspect of the invention, there is provided a meal package, comprising the container of the second aspect of the invention, a food product within the volume and a film sealing the container.

Embodiments of the invention will now be described, by way of example only, with reference to the accompanying drawings, in which:

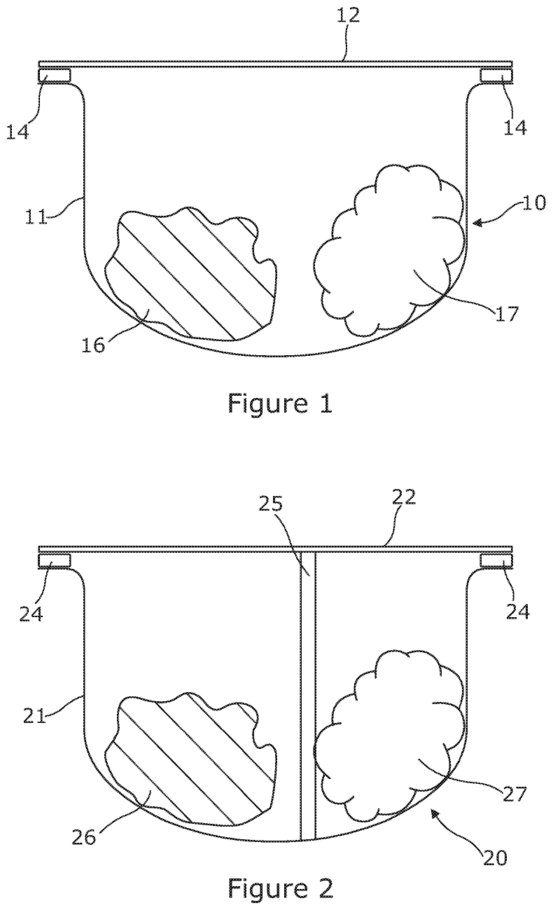

FIG. 1 is a schematic illustration of a front view of a pre-prepared meal package according to an embodiment of the second aspect of the present invention;

FIG. 2 is a schematic illustration of a front view of a pre-prepared meal package according to an embodiment of the second aspect of the present invention;

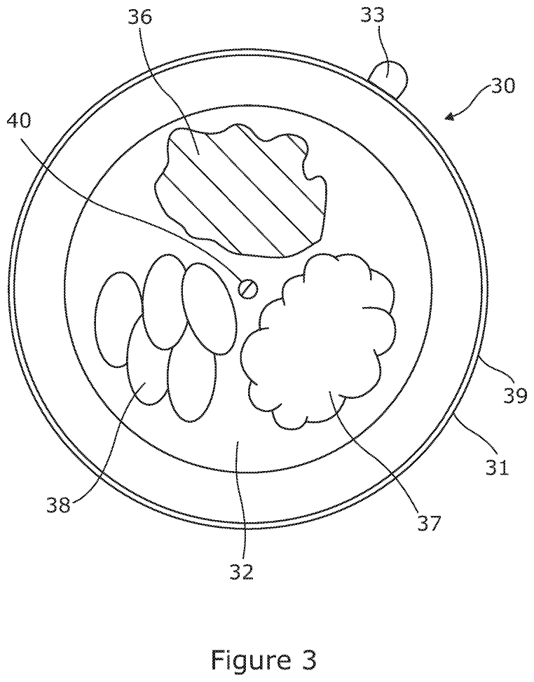

FIG. 3 is a schematic illustration of a top view of a pre-prepared meal package according to an embodiment of the second aspect of the present invention; and

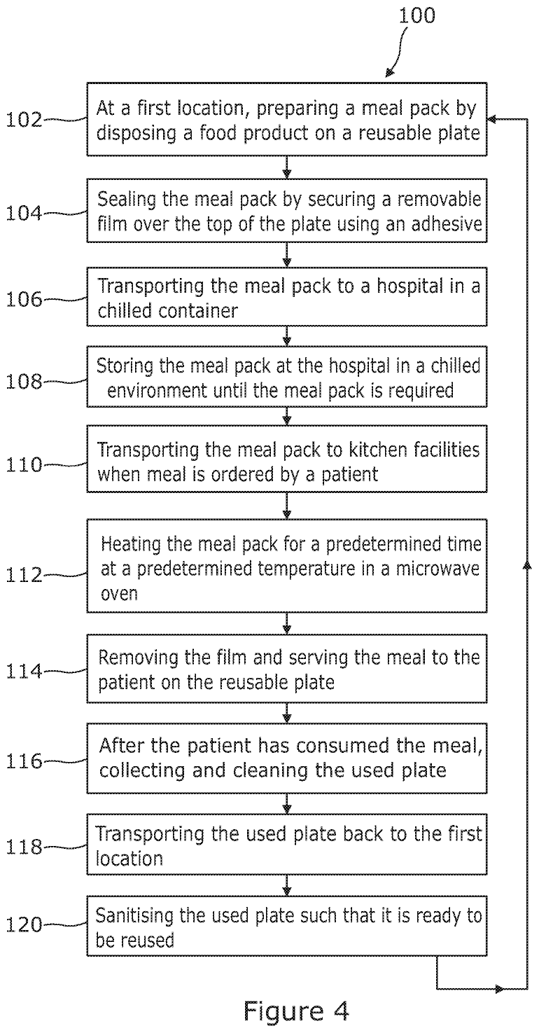

FIG. 4 is a flowchart illustrating a method of preparing and serving a meal package according to an embodiment of the first aspect of the present invention.

FIG. 1 shows an embodiment of a pre-prepared meal package 10 according to the present invention. The meal package 10 comprises a reusable bowl 11 made of polycarbonate which is intended for repeated use in a microwave oven and a commercial dishwasher (or similar device).

The bowl 11 has an opening defining therein a volume for receiving a first food product 16 and a second food product 17. In other embodiments, more than two food products may be disposed in the bowl 11 (for example a source of protein, a carbohydrate and a vegetable). In the example shown in FIG. 1, the food products 16, 17 are not separated.

A film 12 is secured over the opening of the bowl 11 by an adhesive 14 (although in the alternative heat and/or pressure could be used). In this example, the film 12 is a substantially transparent film made of polypropylene. The adhesive 14 may be applied to the outer edge of the film 12 before the film 12 is secured to the bowl 11. Alternatively, the adhesive 14 may be applied to the bowl 11 before applying the film 12 to the adhesive 14.

A second embodiment of a pre-prepared meal package according to the invention is shown in FIG. 2. Features which are common to both FIG. 1 and FIG. 2 are labelled correspondingly where possible.

In FIG. 2, the meal package 20 comprises a reusable bowl 21 having a dividing member 25 configured to separate bowl 21 into a first volume for receiving the first food product 26 and a second volume for receiving the second food product 27. A film 22 is secured by adhesive 24 (although in the alternative heat and/or pressure could be used) over the opening of the bowl 21 such that is encloses both the first and second volumes.

The dividing member 25 splits the bowl 21 into two compartments, each compartment defining a volume therein for receiving one or more food products. This ensures that the food products in the first compartment do not come into contact with the food products in the second compartment either during preparation, heating or serving of the meal. This may make the meal more appealing and improve the quality of the cooking of each separate component of the meal.

However, the dividing member 25 does not have to be disposed through the middle of the bowl 21, thus the compartments do not have to be of equal volume. For example, the volume for receiving the first food product may be larger than the volume for receiving the second food product. This may allow the main component of the meal to be disposed in the largest compartment and one or more side-dishes to be disposed in smaller compartments.

FIG. 3 shows a third embodiment of a pre-prepared meal package 30 according to the present invention. The meal package 30 comprises a reusable plate 31 onto which a first product 36, second food product 37 and third food product 38 are disposed.

A transparent film 32 is secured to an outer rim 39 of the plate 31 using an adhesive 34 (although in the alternative heat and/or pressure could be used). To facilitate the removal (i.e. peeling) of the film 32 from the plate after the meal 30 is heated, the film 32 comprises a tab 33 that extends beyond the outer rim 39 of the plate 31. In some examples, more than one tab 33 may be provided.

The film 32 also comprises a non-return valve 40 which is configured to release steam (i.e. pressure) from the enclosed volume of the plate 31 during heating. This removes the need for the film 32 to be pierced before heating and results in a more efficient steaming of the food products 36, 37, 38.

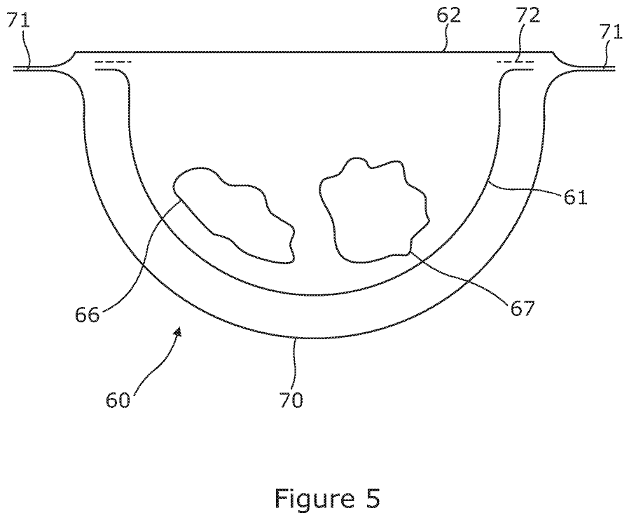

A fourth embodiment of the invention is shown in FIG. 5 of the accompanying drawings. In this embodiment, features corresponding to those of the first embodiment are shown with the corresponding reference numerals raised by 50.

In this embodiment, a pre-prepared meal package 60 is provided. It again includes a re-usable plate 61 on which food products 66, 67 have been placed.

However, there are two layers of film 62, 70. The first layer of film 62 covers the top of the plate 61 as before. However, the second layer of film passes underneath the plate 61, so as to encapsulate the plate 61 and its contents 66, 67. The two layers of film 62, 70 are sealed together at their edges 71, typically by heat and/or pressure sealing or alternatively using a convenient adhesive.

This embodiment reduces the reliance on the seal of the film 62 on the plate 61; it is generally easier to bond like materials (e.g. two identical films, if the layers of film 62, 70 are of the same material). As such, this embodiment may present a more reliable seal. In any case, it is still possible to (optionally) seal the first, top layer of film 62 to the plate 61 at seal 72.

A method 100 of preparing and serving a meal package (or meal pack) according to the present invention to a hospital patient is illustrated in FIG. 4. However, the present invention is not limited to use in a hospital, and may be used in a school, a care home, or other establishment requiring catering facilities.

Step 102 comprises disposing a food product onto a reusable plate, although the same method can also be used for a meal package comprises a different reusable container, for example a bowl or a tray. Step 102 may include disposing a second or third or fourth food product (or more) onto the reusable plate.

The meal package is then sealed, step 104, by securing a removable film over the top of, or around the plate, typically using an adhesive or a heat and/or pressure seal. Each of steps 102 or 104 may be carried out by hand, or by one or more machines, for example in an automated or semi-automated assembly line.

The sealed meal package is then transported in a chilled container to a second location, step 106, which in the example in FIG. 4 is a hospital. Preferably, multiple meal packages are transported in a single journey. The meal packages may be transported in a refrigerated vehicle, or in cool-boxes in a vehicle.

Optionally, the meal package may then be stored at the hospital (or other second location) in a chilled environment, such as a fridge or cold storage room, step 108. The meal package may be stored for up to 7 days before being consumed. In other embodiments, the meal package may be used within a short period of time after it is received at the second location, meaning it doesn't require storage. For example, an establishment that doesn't have sufficient chilled storage facilities, such as a school, may receive a daily delivery of meal packages to be served soon after delivery.

If there is a choice of different meal packages available, the meal package may be transported up to the kitchen facilities of the hospital when the meal is ordered by a patient, step 110. Otherwise, the meal package may be transported to the kitchen facilities upon delivery (if not being stored) or at a given meal time (if there is no system that allows patients to order meals).

The meal package is then heated for a predetermined time at a predetermined temperature in a microwave oven, step 112. The duration and temperature at which the food product is intended to be heated may depend for example on the type of food product, the size of the meal package, or the conditions at which the meal has been stored. The predetermined heating requirements may be indicated on to reusable plate, or the removable film, or any other packaging included in the meal package.

After heating, the removable film is removed from the reusable plate and the meal is served to a patient in the reusable plate, step 114. Preferably, the film is configured to be easily peeled away from the plate in a single piece. After removal the film is disposed of as the film is only intended for a single use.

When the meal has been consumed the reusable plate is collected and cleaned at the second location (i.e. the hospital), step 116. This may include removing any food debris from the plate and inserting the reusable plate into a dishwasher or other cleaning facility. In other embodiments, the plates may be cleaned at the first location, for example if the second location has no suitable cleaning facilities.

The cleaned plates are then transported back to the first location, step 118, where they are sanitised such that they are ready to be reused, step 120. Method steps 102 to 120 are then repeated for the used plate.

1. A method of preparing and serving a meal package comprising the steps of:
preparing a meal package, including:
disposing a food product into a container, the container having an opening defining therein a volume for receiving the food product; and
sealing the container by securing a film over or around the container;
heating the meal package in a microwave oven;
removing the film from the container;
serving the heated food product in the container;
cleaning the used container after the food product has been consumed; and
repeating the above steps for the used container.

2. The method of claim 1, wherein the container is a bowl, or a plate, or a tray.

3. The method of claim 1, wherein the film comprises a non-return valve configured to release steam from the container during heating.

4. The method of claim 1, wherein the film is at least partially formed of polypropylene.

5. The method of claim 1, wherein the container is at least partially formed of polycarbonate.

6. The method of claim 1, wherein the steps of disposing a food product into a container and sealing the container take place at a first location and at least one of the remaining steps take place at a second location.

7. The method of claim 6, wherein the first location is a manufacturing site, such as a factory.

8. The method of claim 6, wherein the second location is a hospital, or a school, or a care home, or any other establishment requiring mass catering facilities.

9. The method of claim 6, further comprising the step of transporting the meal package from the first location to the second location.

10. The method of claim 6, further comprising the step of transporting the used container back to the first location either before or after the used container has been cleaned.

11. The method of claim 1, wherein the container defines therein a first volume and a second volume separated by a dividing member and wherein the step of disposing a food product into the container comprises disposing a first product into the first volume and disposing a second food product into the second volume.

12. The method of claim 11, wherein the container further defines therein a third volume separated from the first and second volumes by at least one further dividing member, and wherein the step of disposing a food product into the container further comprises disposing a third food product into the third volume.

13. The method of claim 1, wherein the food product is disposed into the container in accordance with a predetermined meal specification.

14. The method of claim 6, further comprising the step of storing the meal package in a chilled environment at the second location until the meal package is required to be heated.

15. The method of claim 1, wherein the step of cleaning the used container comprises inserting the used container into a dishwasher or other industrial or commercial dish-cleaning apparatus.

16. The method of claim 1, further comprising the step of sanitising the used container after it has been cleaned.

17. A meal package, comprising a container having an opening defining therein a volume, a food product in the volume and a film sealing the opening, in which the container is at least partially formed of polycarbonate and the film is at least partially formed of polypropylene.

18. The meal package of claim 17, in which the container is suitable to be cleaned, refilled with food product and resealed with a replacement film.

19. The meal package of claim 18, in which the container can be refilled at least 10, 50 or 100, 200 or 350 times.
